(19) United States
(12) Patent Application Publication
(10) Pub. No.: US 2008/0144092 A1
(43) Pub. Date: Jun. 19, 2008

(54) IMAGE FORMING APPARATUS AND METHOD OF CONTROLLING SAME

(75) Inventor: Hiroyuki Kayama, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/950,412

(22) Filed: Dec. 4, 2007

(30) Foreign Application Priority Data
Dec. 13, 2006 (JP) 2006-336382

(51) Int. Cl. G06K 1/00

(52) U.S. Cl. 358/1.15

(57) ABSTRACT

Processing efficiency is improved without executing needless processing when a plurality of processes for implementing functions relating to image formation are executed continuously. To accomplish this, whether processed data that has been generated in a workflow is to be saved or not is determined in accordance with data that has been input by an input step, and switching between execution of a workflow that includes a save process and execution of a workflow without saving processed data is performed in accordance with the result of the determination.

### BACKGROUND OF THE INVENTION

1. Field of the Invention

The present invention relates to an image forming apparatus for performing image formation in accordance with a workflow that defines a plurality of processes, which implement functions relating to image formation, as continuous processing, and to a method of controlling this apparatus.

2. Description of the Related Art

Once the workflow (WF) of a printing operation has been defined, the workflow is executed a number of times not only by a single user but also by a plurality of users. At such times each user repeatedly executes the process steps defined in the workflow.

However, the process steps of a defined workflow also include process steps that do not require repetition multiple times. For example, if the same print data is used, processing (e.g., RIP) for expanding print data stores the data resulting from the RIP, thereby making it possible to curtail process steps relating to RIP.

Using the above-mentioned technique makes it possible to execute a workflow efficiently. However, save processing is not executed automatically; the timing at which print data is saved, the save format and the save location, etc., must be specified by the user.

In order to perform the same printing using saved print data, it is required that the user manage the saved print data in advance. In other words, unless the user him/herself keeps track of the fact that printing has been performed in the past, processing (e.g., RIP) that was executed in the past must be executed repeatedly, wasteful processing occurs and the processing efficiency of the workflow may decline.

A technique for re-utilizing print data has been disclosed for the purpose of solving this problem and enhancing the convenience of print processing (e.g., see the specification of Japanese Patent Application Laid-Open No. 11-249777). A document management system described in Japanese Patent Application Laid-Open No. 11-249777 records print data and a history of the content of processing of this print data in relation to re-utilization of the print data, and determines whether there is a history of output of print data for which output was specified. If such history exists, it would be possible to display who output the print data and when, and also the fact that the data was printed in the past.

With the technique described in Japanese Patent Application Laid-Open No. 11-249777, however, all processed data is the object of save. Therefore, even if there is the possibility that the data cannot be re-utilized, the document management unit described in Japanese Patent Application Laid-Open No. 11-249777 saves the data.

For example, there is the possibility that data that has been input using a scanner cannot be re-utilized owing to a reading irregularity at the time of scanning. However, with the technique described in Japanese Patent Application Laid-Open No. 11-249777, the document management unit always stores the type of operation and data that is the result of the operation. As a consequence, data that cannot be re-utilized is stored.

As a result, when image formation processing has been executed using data that cannot be re-utilized by the user, the result of the image formation processing is not the output result intended by the user. This means that it is necessary for the processing relating to image formation processing to be re-executed from the input step. This is wasteful. Further, in order to perform printing using print data that has been saved, it is required that the user manage the saved print data beforehand. This places a burden upon the user.

### SUMMARY OF THE INVENTION

The present invention is such that when a workflow is executed, processed data based on input data is stored selectively in accordance with input data that has been entered at an input step, thereby making it possible to improve processing efficiency without executing needless processing when a plurality of processes are executed continuously.

One aspect of the present invention provides an image forming apparatus for performing image formation in accordance with a workflow that a plurality of process steps are defined, as continuous processing, comprising: an instruction unit adapted to instruct execution of the workflow; a first determination unit adapted to determine, in accordance with input data that has been input in an input step contained in the workflow, whether or not to save processed data based on the input data generated in the workflow; and a workflow control unit which, in a case that the first determination unit has determined to save processed data, is adapted to add a save step for saving processed data obtained by executing the step before an editing step contained in the workflow to a storage unit before the editing step.

Another aspect of the present invention provides a method of controlling an image forming apparatus for performing image formation in accordance with a workflow that a plurality of process steps are defined, as continuous processing, comprising: an instruction step of instructing execution of the workflow; a first determination step of determining, in accordance with input data that has been input in an input step contained in the workflow, whether or not to save processed data based on the input data generated in the workflow; and a workflow control step which, in a case that the first determination step has determined to save processed data, is a step of adding a save step for saving processed data obtained by executing the step before an editing step contained in the workflow to a storage unit before the editing step.

Still another aspect of the present invention provides a program for causing a computer to execute a method of controlling an image forming apparatus for performing image formation in accordance with a workflow that a plurality of process step are defined, as continuous processing, comprising: an instruction step of instructing execution of the workflow; a first determination step of determining, in accordance with input data that has been input by an input step contained in the workflow, whether or not to save processed data based on the input data generated in the workflow; and a workflow control step which, in a case that the first determination step has determined to save processed data, is a step of adding a save step for saving processed data obtained by executing the step before an editing step contained in the workflow to a storage unit before the editing step.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a network system according to a first embodiment of the present invention;

FIG. 2 is a block diagram illustrating the arrangement of the main components of a copier;

FIG. 3 is a side sectional view illustrating the hardware configurations of a scanner and printer shown in FIG. 2;

FIG. 4 is a plan view illustrating an example of the arrangement of an operation unit shown in FIG. 2;

FIG. 5 is a diagram illustrating an example of the operating screen displayed on the operation unit;

FIG. 6 is a diagram illustrating a screen for managing the workflow of the copier in the first embodiment;

FIG. 7 is a diagram illustrating a screen for registering/editing copier functions in a workflow;

FIG. 8 is a diagram illustrating the constitution of an application program of the copier according to the first embodiment;

FIG. 9 is a diagram illustrating an example of print data information saved in a box area;

FIG. 10 is a flowchart illustrating processing according to which an application program in the copier executes a workflow;

FIG. 11 is a diagram illustrating an example of a screen for inputting the name of print data and hash data;

FIG. 12 is a diagram illustrating an example of a screen for specifying the timing of saving to the box area using the screen for registering/editing copier functions in a workflow; and

FIG. 13 is a diagram illustrating an example of a screen that allows the selection of data to be processed.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

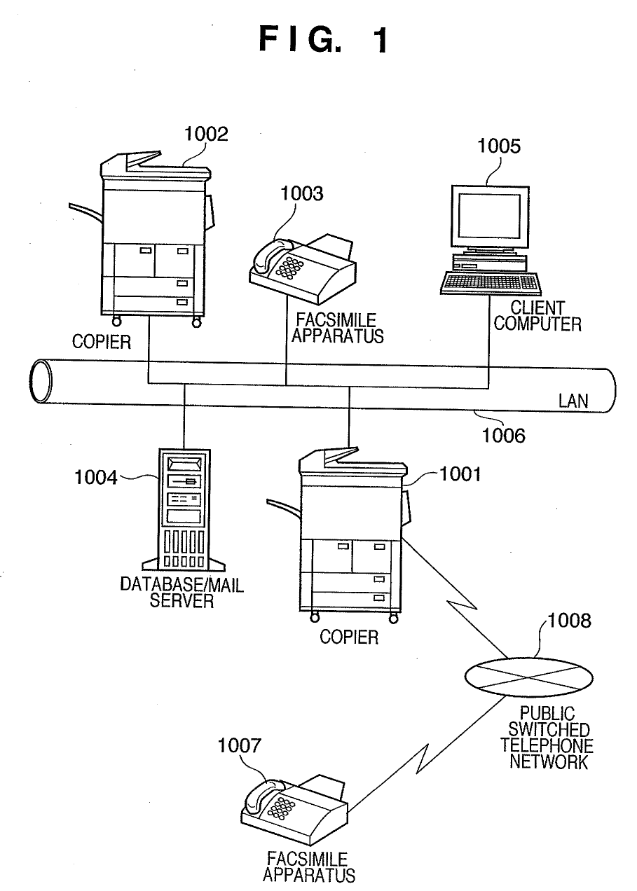

First, reference will be had to FIGS. 1 to 5 to describe the configuration of a system in which a plurality of image forming apparatuses, a server and a computer functioning as a client are connected via a network (LAN), as well as the structure of an image forming apparatus for outputting print data in accordance with a workflow.

FIG. 1 is a diagram illustrating an example of the configuration of a network system according to a first embodiment of the present invention. In the example shown in FIG. 1, the image forming apparatus is a copier having a data transceive function. Here a copier 1001 is connected to a LAN 1006 along with a copier 1002 having functions equivalent to those of the copier 1001, a facsimile apparatus 1003, a database/mail server 1004 and a client computer 1005. The copier 1001 is capable of sending and receiving fax images to and from a facsimile apparatus 1007 via a public switched telephone network 1008.

The copier 1001 has a copy function and a facsimile function as well as a data transceive function for reading a original document and transmitting the read image data to each device on the LAN 1006. Further, the copier 1001 has a PDL (Page Description Language) function for receiving and printing a PDL image specified from the client computer 1005 on the LAN 1006. The copier 1001 stores an image read by the copier 1001 or a PDL image specified from the client computer 1005 on the LAN 1006 in a specified box area of a hard disk within the copier 1001. The copier 1001 is capable of printing an image that has been stored in the box area. The box area will be described later in greater detail.

Further, the copier 1001 receives image data, which has been read by the copier 1002, via the LAN 1006, and stores this image data on the hard disk within the copier 1001 or prints out the image data. Further, the copier 1001 receives image data from the client computer 1005 and database/mail server 1004 via the LAN 1006 and stores this image data in the copier 1001 or prints out this image data.

The facsimile apparatus 1003 receives image data, which has been read by the copier 1001, via the LAN 1006, converts this image data to facsimile data and transmits the facsimile data.

The database/mail server 1004 is a computer having functions for receiving image data, which has been read by the copier 1001, via the LAN 1006, storing this image data in a database and transmitting the image data as e-mail.

The client computer 1005 is connected to the database/mail server 1004, acquires desired data from the database/mail server 1004 and displays this data on a screen. Further, the client computer 1005 receives image data, which has been read by the copier 1001, via the LAN 1006 and manipulates and edits this image data.

The facsimile apparatus 1007 receives an image, which has been read by the copier 1001 and converted to facsimile data, via the public switched telephone network 1008 and prints out this image.

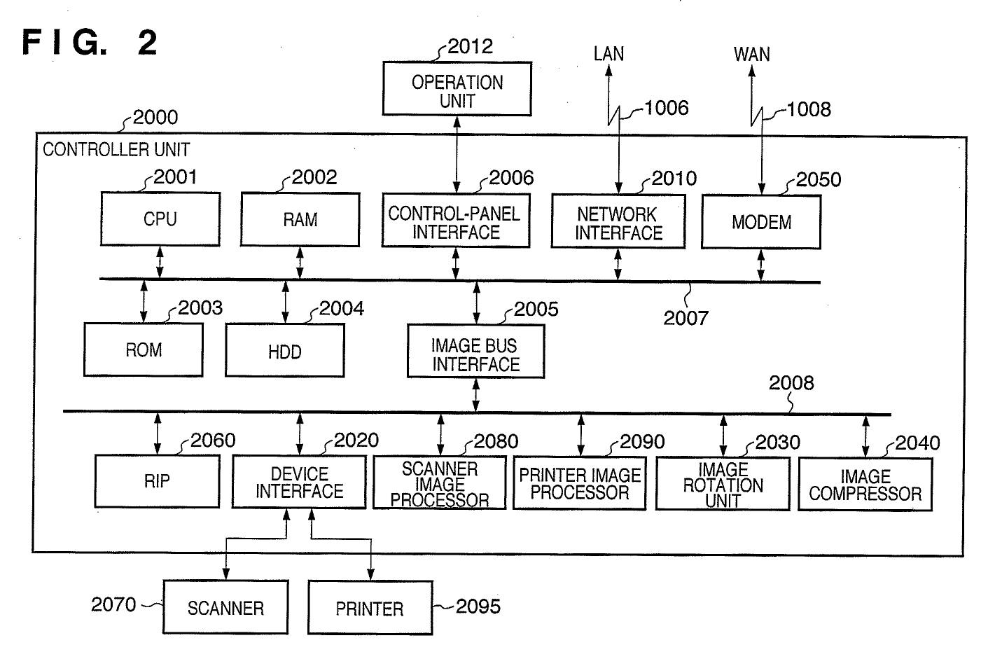

FIG. 2 is a block diagram illustrating the arrangement of the main components of the copier 1001. As illustrated in FIG. 2, the copier 1001 includes a controller unit 2000 connected to a scanner 2070 serving as an image input device, to a printer 2095 serving as an image output device and to an operation unit 2012. The controller unit 2000 exercises control for implementing a copy function according to which image data that has been read by the scanner 2070 is printed out by the printer 2095. By being connected to LAN 1006 or public switched telephone network 1008 (WAN) 2051, the controller unit 2000 is capable of inputting and outputting image information and device information.

The controller unit 2000 has a CPU 2001. The CPU 2001 starts up an operating system using a booting program that has been stored in a ROM 2003. Various processes are executed by executing an application program, which has been stored in a hard-disk drive (HDD) 2004, using the operating system. A RAM 2002 is used as a working area for the CPU 2001. The RAM 2002 provides the working area as well as an image memory area for storing image data temporarily. The hard-disk drive 2004, which includes a box area described later, stores an application program for executing a workflow and image data.

The ROM 2003, RAM 2002, a control-panel interface 2006, a network interface 2010, a modem 2050 and an image bus interface 2005 are connected to the CPU 2001 via a system bus 2007. The control-panel interface (I/F) 2006, which is for interfacing the operation unit 2012 having a touch-sensitive panel, outputs image data displayed on the operation unit 2012 to the operation unit 2012. The control-panel interface 2006 sends the CPU 2001 information that has been input by the user from the operation unit 2012.

The network interface 2010 is connected to the LAN 1006 and inputs and outputs information to and from the devices on the LAN 1006 via the LAN 1006. The modem 2050 is connected to the public switched telephone network 1008 and inputs and outputs information via the public switched telephone network 1008.

An image bus interface 2005 is a bus bridge for connecting the system bus 2007 and an image bus 2008, which transfers image data at high speed, and for converting the data format. The image bus 2008 is constituted by a PCI bus or IEEE 1394. The image bus 2008 is provided with a raster image processor (RIP) 2060, a device interface 2020, a scanner image processor 2080, a printer image processor 2090, an image rotation unit 2030 and an image compressor 2040.

The RIP 2060 expands PDL code into a bitmap image. The device interface (I/F) 2020 is connected to the scanner 2070 and printer 2095 and subjects image data to a synchronous/asynchronous conversion.

The scanner image processor 2080 applies correction, manipulation and editing to image data that has been input from the scanner 2070. The printer image processor 2090 subjects image data that is to be output to the printer 2095 to correction and resolution conversion processing, etc., that conforms to the printer 2095. The image rotation unit 2030 rotates the image. The compression unit 2040 compresses multilevel image data to JPEG data and compresses bi-level image data to JBIG, MMR or MH data. The image compressor 2040 also subjects compressed data to expansion processing.

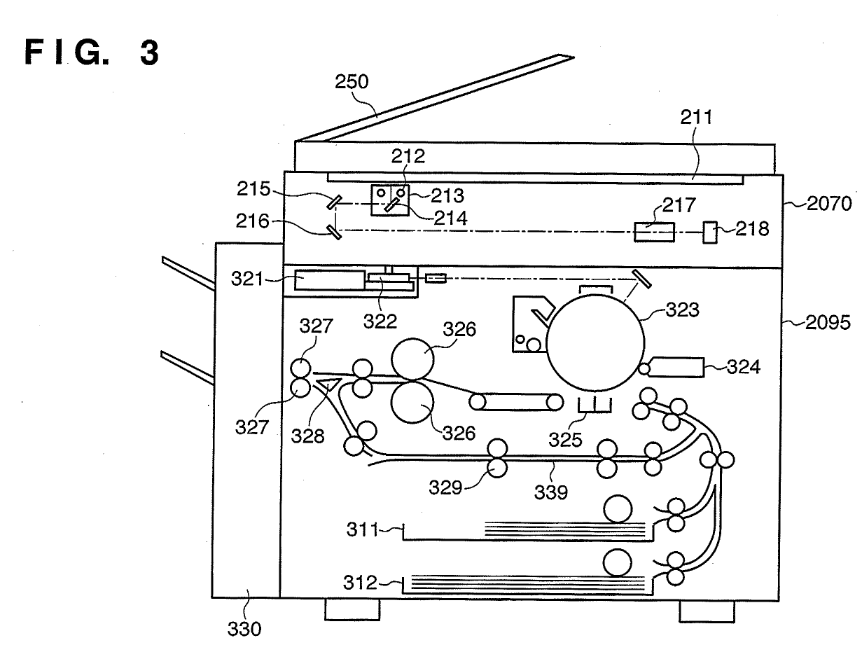

Reference will be had to FIG. 3 to describe an example of the hardware configurations of the scanner 2070 and printer 2095.

FIG. 3 is a side sectional view illustrating the hardware configurations of a scanner 2070 and printer 2095 shown in FIG. 2. As illustrated in FIG. 3, the scanner 2070 and printer 2095 are integrally constructed. A document feeder unit 250 is mounted on the scanner 2070. The document feeder unit 250 feeds documents to the top of a platen glass 211 one sheet at a time in order starting from the first sheet and then ejects the documents from the platen glass 211 into a discharge tray (not shown) whenever the reading of each document is completed. When a original document is transported to the top of the platen glass 211, a lamp 212 in the scanner 2070 is lit and a moving unit 213 is caused to start moving. As a result of movement of the moving unit 213, the document on the platen glass 211 is exposed and scanned. Light reflected from the document owing to this scanning is introduced to a CCD image sensor (referred to as a “CCD” below) 218 by mirrors 214, 215, 216 and a lens 217, as a result of which an image is formed on the image sensing surface of the CCD 218. Thus, the image of the scanned document is read by the CCD 218. Image data output from the CCD 218 is subjected to predetermined processing and then transferred to the controller 110. The CCD 218 converts the image, which has been formed on the image sensing surface, to an electric signal, subjects this electric signal to prescribed processing and then inputs the processed signal to the controller unit 2000.

The printer 2095 has a laser driver 321. The laser driver 321 drives a laser emission unit 322 based upon the image data that has been input from the controller unit 2000. As a result, the laser emission unit 322 emits laser light conforming to the image data. A photosensitive drum 323 is illuminated by the laser light while the drum is scanned by the laser light. An electrostatic latent image is formed on the photosensitive drum 323 and is visualized as a toner image by toner supplied from a developing unit 324. In sync with the timing of the emission of the laser beam, printing paper is fed between the photosensitive drum 323 and a transfer unit 325 from cassettes 311, 312 via the feed path so that the toner image on the photosensitive drum 323 is transferred to the fed printing paper by the transfer unit 325.

The printing paper to which the toner image has been transferred is fed to a pair of fixing rollers (a heating roller and a pressure roller) 326 via a conveyance belt. The pair 326 of fixing rollers apply heat and pressure to the printing paper so that the toner image on the printing paper is fixed to the printing paper. The printing paper that has passed through the pair of fixing rollers 326 is ejected into an ejection unit 330 by a pair of ejection rollers 327. The ejection unit 330 comprises a sheet treating device for applying post-treatment such as sorting and stapling.

If a doubled-sided print mode has been set, the printing paper is fed up to the ejection rollers 327, after which the rotating direction of the ejection rollers 327 is reversed so that the printing paper is introduced to a doubled-sided feed path 339 by a flapper 328. The printing paper that has been introduced to the doubled-sided feed path 339 is again fed between the photosensitive drum 323 and transfer unit 325 at the above-mentioned timing so that a toner image is transferred to the back side of this sheet of printing paper.

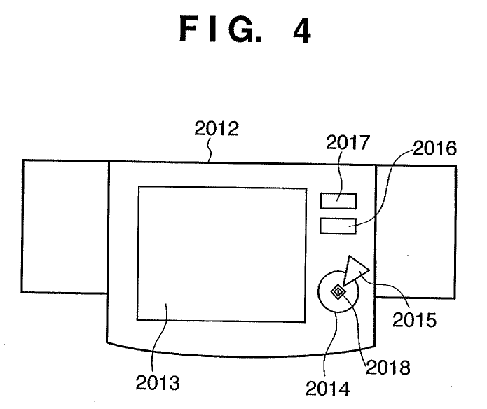

FIG. 4 is a plan view illustrating an example of the arrangement of the operation unit 2012 shown in FIG. 2. An LCD display unit 2013 in FIG. 4 has a structure that includes a touch-sensitive sheet affixed to an LCD. When the LCD display unit 2013 displays the operating screen of the copier 1001 and a key displayed on the screen is pressed, information representing this position is sent to the CPU 2001 of the controller unit 2000.

A start key 2014 is used to start an operation for reading a original document. Provided at the center of the start key 2014 is a two-color (green and red) LED 2018. Whether the start key 2014 is in the usable state is indicated by the color of the LED. A stop key 2015 is operated to stop an operation in progress. An ID key 2016 is used by the user to input a user ID. A reset key 2017 is used to initialize settings from the operation unit 2012.

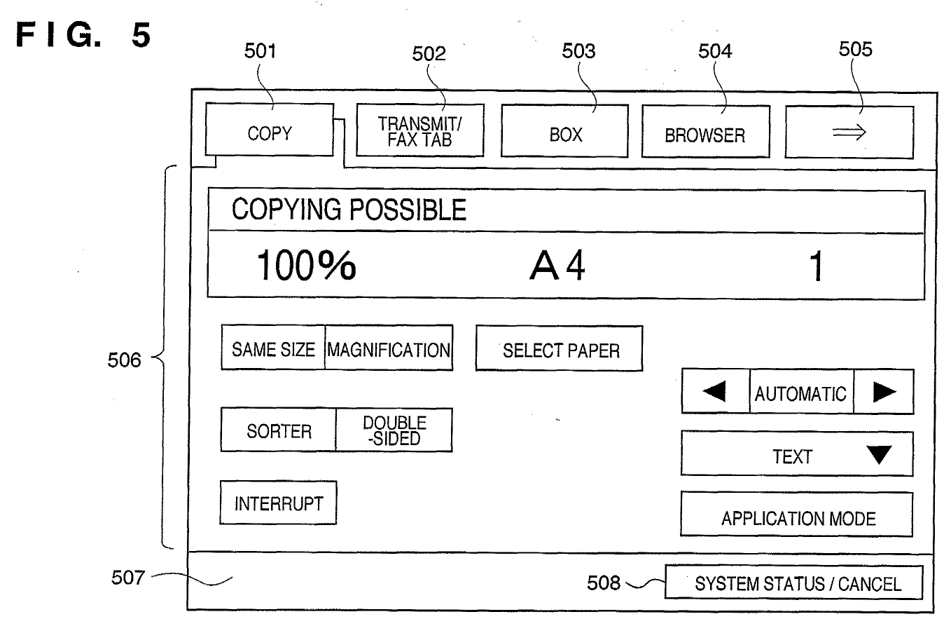

FIG. 5 is a diagram illustrating an example the operating screen displayed on the operation unit 2012. The upper part of the operating screen of operation unit 2012 includes touch-sensitive keys. Displayed are a copy tap 501, a transmit/FAX tab 502, a box tab 503, a browser tab 504 and a right-arrow tab 505 associated with the touch-sensitive keys.

The operating screen shown in FIG. 5 is the initial screen of the copy function and appears when the touch-sensitive key of the copy tap 501 is pressed. The display relating to the copy function is presented in an area 506. Status to be displayed with the copy function is displayed in an area in which “COPYING IS POSSIBLE” is being displayed above. Magnification, the selected paper-feed tray and entry number are displayed.

Further, displayed as touch-sensitive keys for setting operating modes of the copy function are a same-size key, a magnification key, a paper selection key, a sorter key, a double-sided print key, an interrupt key, a text key, a left-arrow key for reducing density, a right-arrow key for increasing density and an automatic key for adjusting density automatically. It should be noted that screens for specifying operating modes that will not fit on the initial screen will be displayed in area 506 hierarchically by pressing an application mode key.

Further, a display area 507 displays the status of the copier 1001. For example, this area displays an alarm message such as a paper-jam message, or a status message indicating that PDL printing is in progress when PDL printing is being carried out. A system status/cancel touch-sensitive key 508 is displayed in the display area 507. When this key is pressed, a screen that displays the device information of the copier 1001 or a screen (not shown) that displays the status of the print job is displayed. A print job can be cancelled using this screen.

Further, when the transmit/FAX tab 502 is pressed, this causes display of a setting screen (not shown) for facsimile transmission of image data, which has been read by the copier 1001, to a device on the LAN 1006 using e-mail transmission, FTP transmission or public circuit.

When the box tab 503 is pressed, this causes display of a setting screen (not shown) for saving image data, which has been read by the copier 1001, in a box area within the hard-disk drive 2004, or for specifying image data that has been saved, printing the image data or transmitting it to a device on the LAN 1006.

In a case that the controller unit 2000 has been equipped with five or more functions, the right-arrow tab 505 is displayed on the right side of the tabs for the copy, transmit/FAX, box and browser functions. When the right-arrow tab 505 is pressed, a screen for another function is displayed.

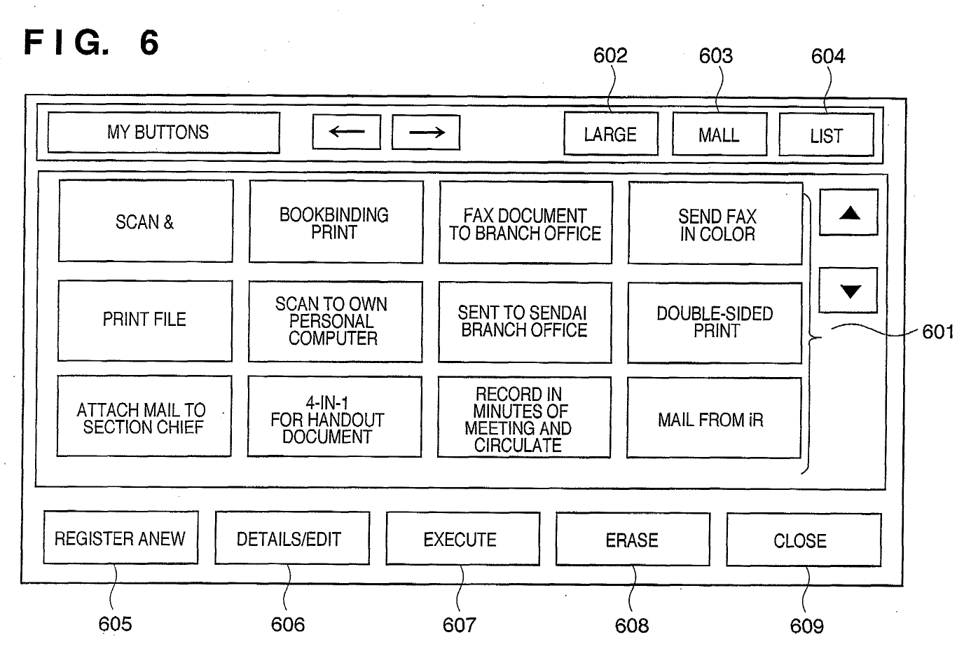

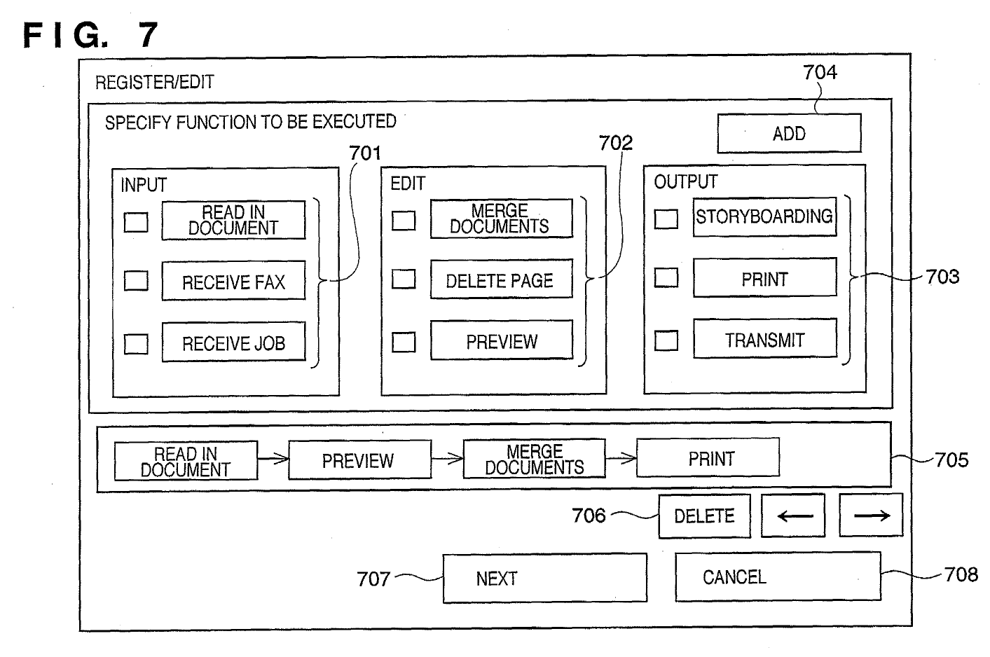

Next, reference will be had to FIGS. 6 and 7 to describe processing whereby a user registers a desired workflow using the copier 1001 having the configuration described above.

FIG. 6 is a diagram illustrating a screen for managing the workflow of the copier 1001 in the first embodiment. Here the term “workflow” signifies continuous processing of a plurality of copier functions. Further, “copier functions” refer to functions such as reading of a original document, FAX reception, merging of documents, page deletion, storyboarding, printing and transmission, etc.

When the user presses the right-arrow tab. 505 on the operating screen of FIG. 5, the CPU 2001 displays the workflow management screen shown in FIG. 6. A workflow is executed as a result of the user selecting one of a number of workflow buttons 601 and pressing an execute button 607. In the example shown in FIG. 6, the form of the display can take on any of three patterns, namely large, small or list, depending upon which of three buttons 602 to 604 is pressed.

Further, if a button 605 for newly registering a workflow management screen is pressed, or if a details/edit button 606 is pressed with a workflow in the selected state, then the CPU 2001 displays an edit/register screen illustrated in FIG. 7.

FIG. 7 is a diagram illustrating a screen for registering/editing copier functions in a workflow. The copier functions are selected from among each of input buttons 701, edit buttons 702 and output buttons 703, and a selected function is added to a list 705 by pressing an add button 704. The list 705 is displayed in accordance with the order of the copier functions to be executed. The example depicted in FIG. 7 indicates a workflow of selected copier functions, namely that document read has been selected from among the input buttons 701, preview and document merge from among the edit buttons 702 and print from among the output buttons 703.

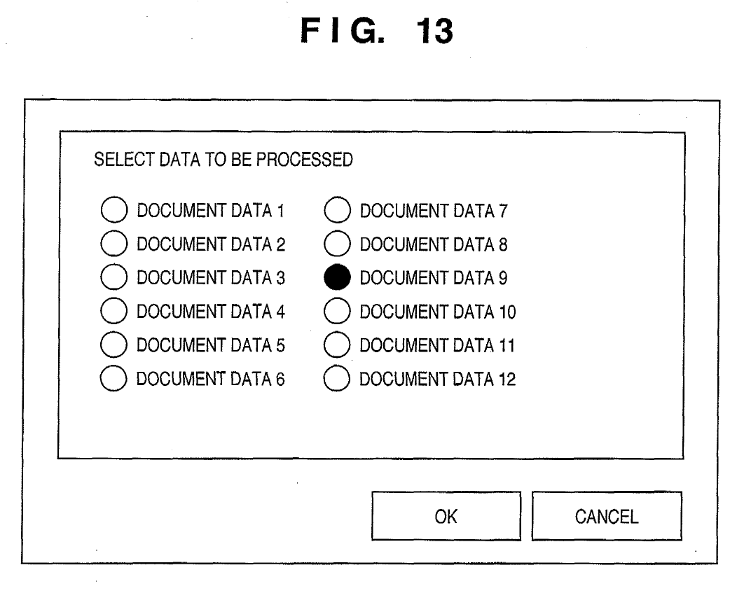

The content of processing selected by the input buttons 701 is an input process, the content of processing selected by the edit buttons 702 is an edit process, and the content of processing selected by the output buttons 703 is an output process. The input processing is not just processing for actually reading and inputting a original document as by scanner processing at execution of the workflow but also includes processing for specifying data that has already been stored in a storage unit of the image forming apparatus or processing for specifying a box, which is a save area. Therefore, if “RECEIVE JOB” has been selected from among the input buttons 701 of FIG. 7, then list information indicating data being held in the storage unit of the image forming apparatus is displayed, as illustrated in FIG. 13. Data selected from this list information becomes input data that is input in the input process, which is receipt of the job.

In FIG. 13, “DOCUMENT DATA 9” being held in the storage unit of the image forming apparatus has been selected as the input data. Further, if a workflow in which “RECEIVE JOB” has been selected as the input process without selecting document data via FIG. 13, then the print data may be received from an information processing apparatus in accordance with execution of this workflow.

Further, a copier function that has been added on can be edited by using delete/move buttons 706. By pressing a “NEXT” button, a screen (not shown) for setting each of the copier functions in detail is displayed. If a “CANCEL” button 708 is pressed, then the editing of a copier function is cancelled and the screen of FIG. 6 is restored.

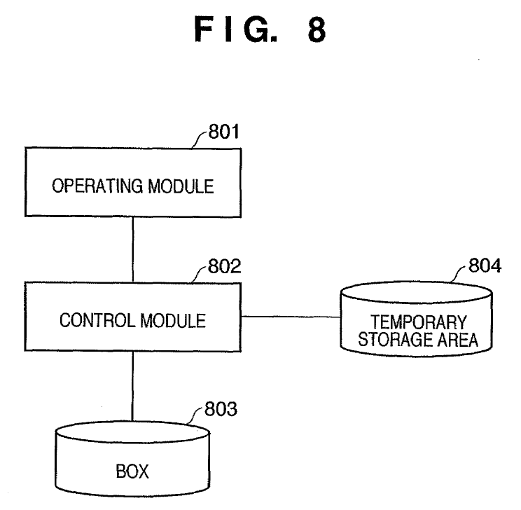

Next, reference will be had to FIGS. 8 to 10 to describe to describe processing for executing a workflow and saving print data and hash data, etc., in a box area using the copier 1001.

FIG. 8 is a diagram illustrating the constitution of an application program of the copier 1001 according to the first embodiment. By pressing the execute button 607 shown in FIG. 6, a control module 802 executes a workflow in response to an instruction from an operating module 801. The control module 802 conducts a search to determine whether print data capable of being utilized in the workflow has been saved in a box area 803. If utilizable print data has been saved, then the control module 802 executes the workflow in mid-course using this print data.

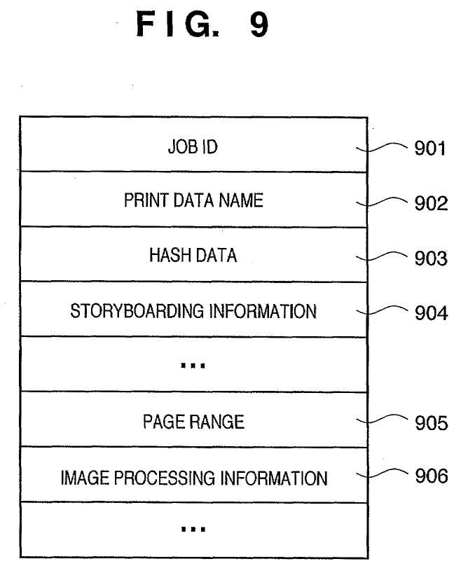

If utilizable print data has not been saved, on the other hand, then the control module 802 analyzes the workflow and determines the timing for saving print data. The control module 802 executes the workflow and saves the print data and print data information in the box area 803. Saved information will be described in further detail with reference to FIG. 9.

A temporary storage area 804 is an area in which the name of the print data, the hash data and processing that was executed up to storage of the print data in the box area 803 are stored temporarily in advance.

FIG. 9 is a diagram illustrating an example of print data information saved in the box area 803. A job ID 901 allows the control module 802 to identify the job. Print data name 802 indicates the name of the print data. Hash data 903 identifies the print data uniquely.

It is assumed here that the hash data is generated using a hash function whereby a different hash value is obtained from different print data, by way of example.

Reference numerals 904, 905 and 906 denote storyboarding information, page range and image processing information as processing that has been executed by the copier 1001 up to the saving of data in the box area 803.

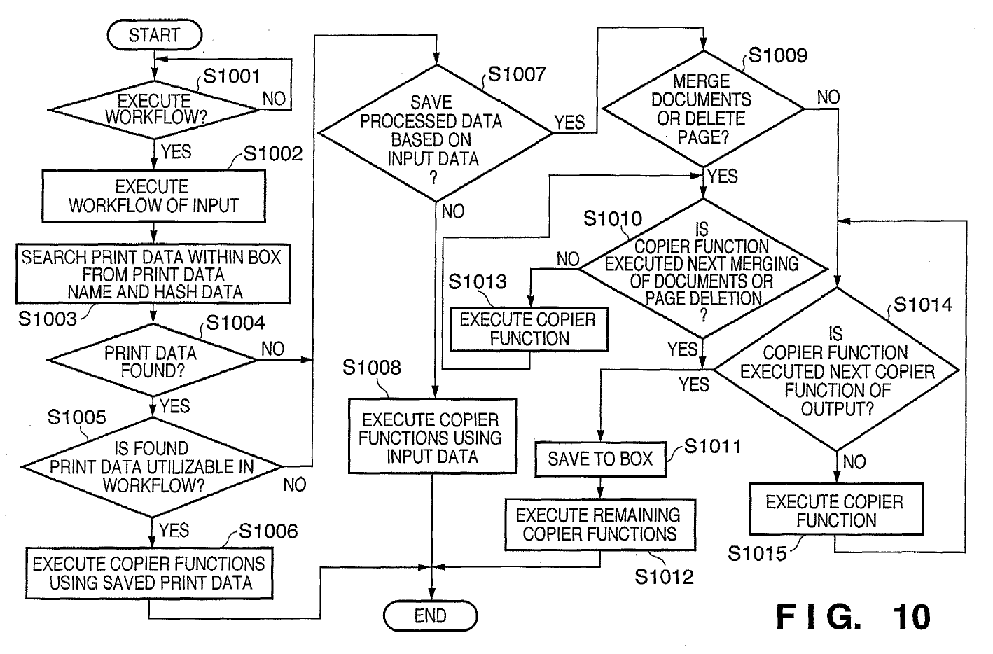

FIG. 10 is a flowchart illustrating processing according to which an application program in the copier 1001 executes a workflow. The processing of each step in FIG. 10 is executed by the copier 1001. First, at step S1001, the operating module 801 determines whether execution of a workflow has been specified by the user. If the result of determination is that execution of a workflow has been specified, then the operating module 801 instructs the control module 802 to execute the workflow. Processing then proceeds to step S1002.

At step S1002, the control module 802 executes the input process of the workflow specified by the user. At this time the control module 802 saves the name of print data and the hash data of the print data in the temporary storage area 804 in accordance with the processing of the input process. Specifically, if the input of the workflow is reception of a job, then the control module 802 obtains the hash data of the print data selected via the operating screen of FIG. 13 and saves the hash data to the temporary storage area 804 together with the name of the print data. Further, if the input of the workflow is the reading of a original document, then the control module 802 obtains the hash data of the image data representing the read document and saves this hash data to the temporary storage area 804 together with the name of the document. Further, if the input of the workflow is receipt of FAX or receipt of I-FAX, then the control module 802 saves the name of the received data and the hash data to the temporary storage area 804.

At step S1003, the control module 802 searches the print data in the box area 803 using as a key the name of the print data and the hash data, which have been saved to the temporary storage area 804, in order that the print data that has been input in the input process at step S1002 will be specified. When the search ends, the control module 802 determines at step S1004 whether print data was found at step S1003. If the result is that print data was found, control proceeds to step S1005. If the print data was not found, then control proceeds to step S1007. In other words, the control module 802 determines whether processed data that is utilizable in the workflow whose execution was specified at step S1001 has been saved to the storage unit of the image forming apparatus.

At step S1005, on the basis of the setting information 904 to 906 in the print data information, the control module 802 determines whether the print data retrieved at step S1003 is utilizable in the workflow. For example, if the storyboarding information 904 of the print data stored in the box area 803 is 4-in-1 (plural storyboarding) and a 2-in-1 storyboarding copier function has been specified in the workflow to be executed, then further storyboarding will be difficult to perform. Therefore, the determination made is that the data is not utilizable. Further, if the storyboarding information 904 of the print data stored in the box area 803 is 1-in-1, it is determined that the print data is utilizable even in a case that a storyboarding copier function has been specified.

It should be noted that in a case that it is determined that print data was found at step S1004 in the flowchart of FIG. 10, the processing of step S1005 is executed. However, the determination processing of step S1005 need not be executed. In such case the control module 802 executes the workflow specified at step S1001 using the data that was found at step S1004.

If it is determined at step S1005 that the data is utilizable, then control proceeds to step S106. If it is determined that the data is not utilizable, then control proceeds to step S1007.

At step S1006, the control module 802 executes the workflow from mid-course to the end using the print data in the box area 803. That is, the control module 802 executes editing (preview, merging of documents or page deletion) specified in the workflow and output (storyboarding, printing or transmission). In this case, processing efficiency is improved using saved data without performing RIP processing that was executed up to saving of the data in the box area 803. Further, the control module 802 executes continuous processing with regard to a plurality of processes without saving processed data generated in the workflow executed at step S1002.

At step S1007, the control module 802 determines whether to save processed data based on input data obtained by executing the workflow in accordance with the input data that was input by the input process contained in the workflow whose execution has been specified. Specifically, the control module 802 determines whether the data that was input by the input process of the workflow whose execution was specified at step S1001 is processed data based on a print job or data that was input by image reading processing. If the input data that was input by the input process of the work flow is a print job originated from an information processing apparatus, then the control module 802 determines to save the processed data based on this print job (“YES” at step S1007).

On the other hand, if the input data that was input by the input process of the workflow is data that was input by image reading processing, the control module 802 determines not to save the processed data based on this input data (“NO” at step S1007). If the “YES” determination is made at step S1007, then control proceeds to step S1009. If the “NO” determination is made at step S1007, then control proceeds to step S1008. As another specific example of the determination processing at S1007, the determination may be made based upon the source of the input data.

In this case, the control module 802 determines whether data that was input by the input process is data originated from a prescribed source. If the data is data originated from a prescribed source, then the control module determines to save the processed data based on this data (“YES” at step S1007). On the other hand, if the data is not data originated from a prescribed source, the control module 802 determines not to save the processed data based on this data (“NO” at step S1007). It should be noted that in a case that the determination processing at S1007 is executed using the source user, it is necessary that a source user which will be the prescribed source be set as a save condition for saving processed data based on the input data.

As another specific example of the determination processing at S1007, the control module 802 may make the “YES” determination at S1007 in a case that it is determined that the processing content of the input process is a print job and, moreover, that the source of the job is a prescribed source.

At step S1008, the control module 802 executes all copier functions of the workflow using input print data such as read image data and received FAX data. It should be noted that in a case that the input of the workflow is reading of a original document or receipt of a FAX, the image data changes whenever an input is executed and it is difficult to use this image data elsewhere when the next workflow is executed. At step S1008, therefore, the control module 802 executes continuous processing with regard to a plurality of processes without saving the processed data obtained by executing the workflow.

At step S1009, the control module 802 determines whether the edit copier functions include merging of documents or page deletion. In a case that merging of documents or page deletion is included, control proceeds to step S1010. If merging of documents or page deletion is not included, control proceeds to step S1014.

At step S1010, the control module 802 determines whether the copier function executed next in the workflow being executed is merging of documents or page deletion. If the result of the determination is that the function is not merging of documents or page deletion, control proceeds to step S1013. Here the copier function is executed, the content of processing is saved to the temporary storage area 804 and control returns to step S1010.

If it is determined at step S1010 that the copier function executed next is merging of documents of page deletion, control proceeds to step S1011, where the control module 802 saves the print data in the box area 803. This is so that the print data is utilized again in a case that the workflow is executed next. The control module 802 therefore executes continuous processing with regard to a plurality of processes that include save processing for saving processed data obtained by executing the workflow at step S1011 to the storage unit of the image forming apparatus.

At this time the print-data save format is decided in accordance with the copier function of the output. For example, the print data is saved in the JPEG format if the output is printing. Further, the name of the print data, the hash data and content of processing that have been stored in the temporary storage area 804 are saved in the box area 803 as print data information. Control then proceeds to step S1012, where the control module 802 executes all unexecuted copier functions in this workflow.

At step S1014, the control module 802 determines whether the copier function executed next in the workflow being executed is output. If output is to be executed, control proceeds to step S1011. Otherwise, control proceeds to step S1015.

At step S1015, the control module 802 executes the copier function that has been specified. Control then proceeds to step S1014.

In the first embodiment, the search of executable print data is conducted by the copier 1001. However, the name of the print data and the hash data may be transmitted to another image forming apparatus (e.g., copier 1002) and a search conducted. A copier in which utilizable print data has been saved may execute the workflow using this print data.

Further, in the flowchart of FIG. 10, if the “YES” decision is rendered by the determination processing of step S1007, processing at S1011 for saving data in the box is executed after the determination processing of S1009 or S1014 is executed. However, this does not impose a limitation; the control module may execute the workflow as follows: If the control module 802 has determined at step S1007 to save processed data based on the input data, then the control module 802 executes continuous processing with regard to a plurality of processes that include processing for saving processed data, which is obtained by executing the workflow, in the box. On the other hand, if the control module has determined at step S1007 not to save processed data based on the input data, then the control module 802 executes continuous processing with regard to a plurality of processes without saving processed data, which is obtained by executing the workflow, in the box.

In accordance with the first embodiment, processed data based on selectively re-utilizable input data is stored in the storage unit of an image forming apparatus in accordance with the input data. This makes it possible to reduce needless processing by the user.

Furthermore, in accordance with the first embodiment, the workflow to be executed is analyzed, the optimum timing for saving print data and the save format are discriminated and the print data is saved during the course of processing. When the workflow is executed, the workflow is executed automatically in mid-course using the print data that has been saved. As a result, the burden upon the user in terms of managing saved data is alleviated. In addition, it is possible to reduce needless processing, namely the re-execution of all printing-related processing from the beginning.

Previously, it was explained that the control module 802 saves the processed data before it is edited by the editing step (ex. merging of documents or page deletion).

However, the control module 802 can save the processed data before it is edited by the editing step and the processed data after it is edited by the editing step. In addition, the control module 802 can selectively save the processed data before it is edited by the editing step or the processed data after it is edited by the editing step.

### Second Embodiment

A second embodiment according to the present invention will now be described in detail with reference to the drawings. In the first embodiment, the copier functions of the input are executed and the name of print data and hash data are analyzed when execution of the workflow starts. However, it is also permissible to apply a method of allowing the user to input the name of print data and hash data from an operating unit, or a method of accepting the name of print data and hash data from a client computer.

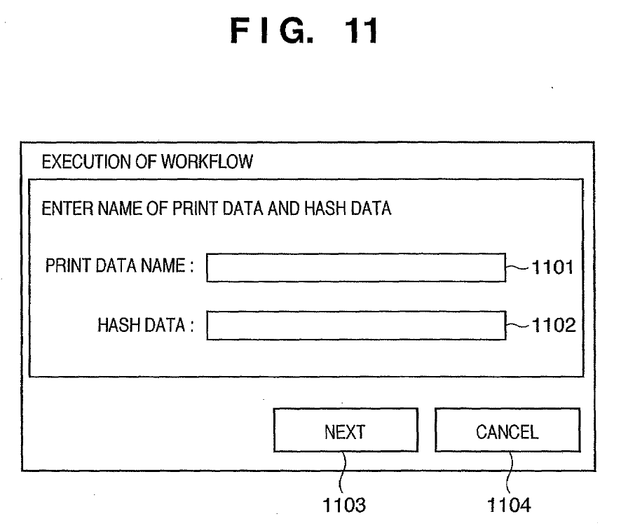

FIG. 11 is a diagram illustrating an example of a screen for inputting the name of print data and hash data. As shown in FIG. 11, by allowing the user to input the name of print data and hash data or accepting the name of print data or hash data from a source of FAX reception or a source of job reception before the copier functions of an input in a workflow are executed, input processing can be curtailed. Further, network traffic due to the sending and receiving of print data in FAX reception or job reception can be reduced.

### Third Embodiment

A third embodiment according to the present invention will now be described in detail with reference to the drawings. In the first embodiment, the timing at which print data and print data information are saved in the box area 803 are decided automatically by the control module 802. However, the user may be allowed to specify the timing of saving to the box area 803.

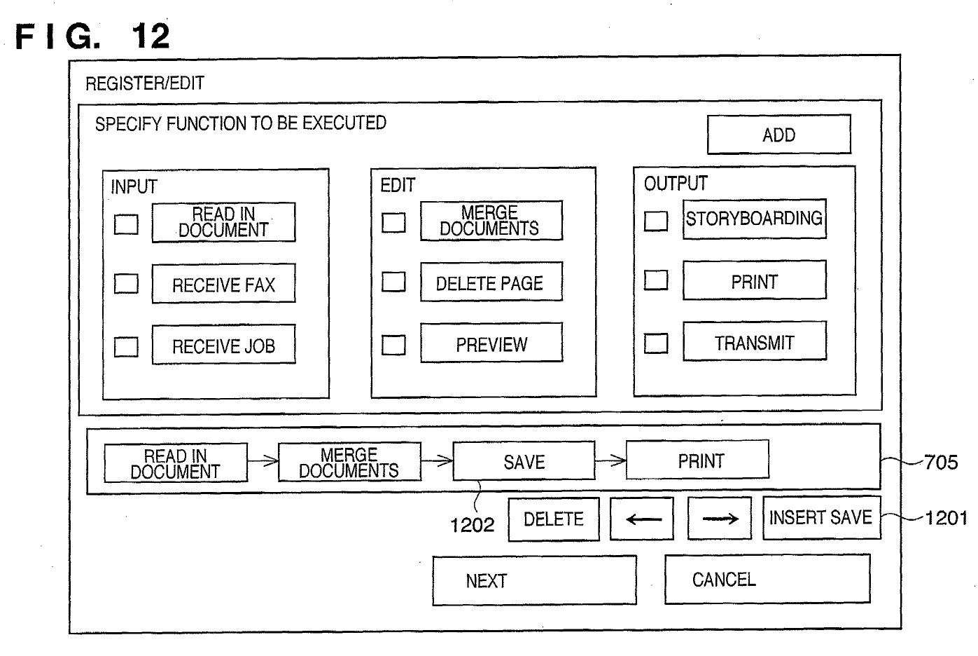

FIG. 12 is a diagram illustrating an example of a screen for allowing a user to specify the timing of saving to the box area 803 using the screen for registering/editing copier functions in a workflow. As illustrated in FIG. 12, “SAVE” is inserted into the workflow list 705 in response to pressing of a save-insert button 1201 by the user.

In accordance with the third embodiment, the user can specify the timing at which data is saved to the box area 803 using the screen for registering/editing copier functions in the workflow.

The present invention may be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a recording medium storing the program codes of the software for performing the functions of the foregoing embodiments to a system or an apparatus, reading the program codes with a computer (e.g., a CPU or MPU) of the system or apparatus from the recording medium, and then executing the program codes.

In this case, the program codes read from the recording medium implement the novel functions of the embodiments and the recording medium storing the program codes constitutes the invention. Examples of recording media that can be used for supplying the program code are a flexible disk, hard disk, optical disk, magneto-optical disk, CD-ROM, CD-R, magnetic tape, non-volatile type memory card or ROM, etc.

Furthermore, besides the case where the aforesaid functions according to the embodiments are implemented by executing the program codes read by a computer, it goes without saying that the present invention covers a case where an operating system or the like running on the computer performs a part of or the entire actual process based upon the designation of program codes and implements the functions according to the embodiments.

It goes without saying that the present invention further covers a case where, after the program codes read from the recording medium are written to a memory provided on a function expansion board inserted into the computer or to a memory provided in a function expansion unit connected to the computer, a CPU or the like provided on the function expansion board or function expansion unit performs a part of or the entire process based upon the designation of program codes and implements the functions of the above embodiments.

In accordance with the present invention, processing efficiency can be improved without executing needless processing when a plurality of processes for implementing functions relating to image formation are executed continuously.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-336382, filed on Dec. 13, 2006, which is hereby incorporated by reference herein in its entirety.

What is claimed is:

1. An image forming apparatus for performing image formation in accordance with a workflow that a plurality of process steps are defined, as continuous processing, comprising:
an instruction unit adapted to instruct execution of the workflow;
a first determination unit adapted to determine, in accordance with input data that has been input in an input step contained in the workflow, whether or not to save processed data based on the input data generated in the workflow; and
a workflow control unit which, in a case that said first determination step has determined to save processed data, is adapted to add a save step for saving processed data obtained by executing the step before an editing step contained in the workflow to a storage unit before the editing step.

2. The apparatus according to claim 1, further comprising a second determination unit adapted to determine whether or not processed data utilizable in a workflow the execution of which has been instructed by said instruction unit has been saved to the storage unit;
wherein in a case that said second determination unit has determined that processed data utilizable in the workflow has been saved to the storage unit, said workflow control unit executes continuous processing with regard to a plurality of processes using the utilizable processed data without saving processed data obtained by executing the workflow.

3. The apparatus according to claim 1, wherein in a case that input data that has been input in the input step of the workflow is a print job originated from an information processing apparatus connected to said image forming apparatus, said first determination unit determines to save processed data based on this print job; and in a case that input data that has been input in the input step of the workflow is data that has been input by image reading processing, said first determination unit determines not to save processed data based on this input data.

4. The apparatus according to claim 1, wherein in a case that input data that has been input in the input step of the workflow is data originated from a predetermined source, said first determination unit determines to save processed data based on this input data; and in a case that input data that has been input in the input step of the workflow is not data originated from a predetermined source, said first determination unit determines not to save processed data based on this input data.

5. The apparatus according to claim 4, further comprising a setting unit adapted to set a save condition for saving processed data based on the input data;
wherein said setting unit sets an originating user, which is a predetermined source, as a save condition; and
in a case that the input data is data originated by the originating user that is the predetermined source, said first determination unit determines to save processed data based on this input data; and in a case that the input data is not data originated by the originating user that is the predetermined source, said first determination unit determines not to save processed data based on this input data.

6. The apparatus according to claim 1, wherein in a case that content of processing in the input step is a scan function for reading a original document or a FAX reception function for receiving FAX data, said first determination unit determines not to save processed data obtained by executing the workflow to the storage unit.

7. The apparatus according to claim 1, wherein the editing step is such that a function relating to the image formation is at least merging of documents or page deletion.

8. A method of controlling an image forming apparatus for performing image formation in accordance with a workflow that a plurality of process steps are defined, as continuous processing, comprising:
an instruction step of instructing execution of the workflow;
a first determination step of determining, in accordance with input data that has been input in an input step contained in the workflow, whether or not to save processed data based on the input data generated in the workflow; and
a workflow control step which, in a case that said first determination step has determined to save processed data, is a step of adding a save step for saving processed data obtained by executing the step before an editing step contained in the workflow to a storage unit before the editing step.

9. The method according to claim 8, further comprising a second determination step of determining whether or not processed data utilizable in a workflow the execution of which has been instructed at said instruction step has been saved to the storage unit;
wherein in a case that said second determination step has determined that processed data utilizable in the workflow has been saved to the storage unit, said workflow control step executes continuous processing with regard to a plurality of processes using the utilizable processed data without saving processed data obtained by executing the workflow.

10. The apparatus according to claim 8, wherein in a case that input data that has been input in the input step of the workflow is a print job originated from an information processing apparatus connected to said image forming apparatus, said first determination step determines to save processed data based on this print job; and in a case that input data that has been input in the input step of the workflow is data that has been input by image reading processing, said first determination step determines not to save processed data based on this input data.

11. The method according to claim 8, wherein in a case that input data that has been input in the input step of the workflow is data originated from a predetermined source, said first determination step determines to save processed data based on this input data; and in a case that input data that has been input in the input step of the workflow is not data originated from a predetermined source, said first determination step determines not to save processed data based on this input data.

12. The method according to claim 11, further comprising a setting step of setting a save condition for saving processed data based on the input data;
wherein said setting step sets an originating user, which is a predetermined source, as a save condition; and
in a case that the input data is data originated by the originating user that is the predetermined source, said first determination step determines to save processed data based on this input data; and in a case that the input data is not data originated by the originating user that is the predetermined source, said first determination step determines not to save processed data based on this input data.

13. The method according to claim 8, wherein in a case that content of processing in the input step is a scan function for reading a original document or a FAX reception function for receiving FAX data, said first determination step determines not to save processed data obtained by executing the workflow to the storage unit.

14. The method according to claim 8, wherein the editing is such that a function relating to the image formation is at least merging of documents or page deletion.

15. A program for causing a computer to execute a method of controlling an image forming apparatus for performing image formation in accordance with a workflow that a plurality of process step are defined, as continuous processing, comprising:
an instruction step of instructing execution of the workflow;
a first determination step of determining, in accordance with input data that has been input by an input step contained in the workflow, whether or not to save processed data based on the input data generated in the workflow; and
a workflow control step which, in a case that said first determination step has determined to save processed data, is a step of adding a save step for saving processed data obtained by executing the step before an editing step contained in the workflow to a storage unit before the editing step.

16. A computer-readable storage medium storing the computer program set forth in claim 15.
